(19) United States
(12) Patent Application Publication
(10) Pub. No.: US 2026/0340173 A1
(43) Pub. Date: Oct. 29, 2026

(54) CYBER SECURITY DATA PRODUCTS AND DATA PROVISIONING

(71) Applicant: WELLS FARGO BANK, N.A., San Francisco, CA (US)

(72) Inventors: Mouli Ravilla, Glen Mills, PA (US); Harish Soma, Hyderabad (IN)

(21) Appl. No.: 19/187,792

(22) Filed: Apr. 23, 2025

(51) Int. Cl. G06F 21/62; G06F 21/60; H04L 67/06

(52) U.S. Cl. CPC G06F 21/6227; G06F 21/604; H04L 67/06

(57) ABSTRACT

Systems and methods for provisioning data. A method includes receiving a verified data configuration file. The method also includes parsing the verified data configuration file to extract a data provisioning schema. The data provisioning schema defines at least a query field having one or more filtering parameters and at least one target dataset comprising a plurality of data values. The method includes extracting the plurality of data values of the at least one target dataset. The method also includes formatting the plurality of data values of the at least one target dataset in accordance with the data provisioning schema to thereby generate a provisioned data file and transmitting the provisioned data file.

### TECHNICAL FIELD

The present disclosure generally relates computer-based systems and methods for managing data, and more particularly to a data provisioning architecture.

### BACKGROUND

A number of technology platforms exist that provide users or businesses with the ability to collect and store large amounts of data. Databases may exist to provide users or businesses the ability to gain insights on data. Databases may also include data that describes the stored data, which is referred to as metadata. Much of the data that is consumed by end users or businesses comes from multiple upstream systems and sources. The volume, complexity, and changing nature of data and metadata makes it difficult to maintain, and there is a need in the art for improved techniques for managing data.

### SUMMARY

Certain aspects and features of the present disclosure generally relate to computer-based systems and methods for managing data. More particularly, certain aspects and features of the present disclosure relate to a data provisioning architecture that provides a self-servicing capability to provision data for downstream applications. According to an aspect of the present disclosure, a method includes receiving, by a data provisioning computing system from a data storage unit, a verified data configuration file. The method also includes parsing, by the data provisioning computing system, the verified data configuration file to extract a data provisioning schema. The data provisioning schema defines a query field having one or more filtering parameters and at least one target dataset comprising a plurality of data values. The method also includes extracting, by the data provisioning computing system, the plurality of data values of the at least one target dataset. The method also includes formatting, by the data provisioning computing system, the plurality of data values of the at least one target dataset in accordance with the data provisioning schema to thereby generate a provisioned data file. The method also includes transmitting, by the data provisioning computing system to a target application computing device, the provisioned data file.

The above system may be implemented in a cloud service executed on cloud service provider infrastructure, which may include various servers, processors, and databases. The above system can also be implemented as computer-executable program instructions stored in a non-transitory, tangible computer-readable medium or media and/or operating within a system including one or more processors or other processing device and memory.

According to an additional aspect of the present disclosure, a system includes one or more processors and a memory coupled to the one or more processors. The memory including instructions that, when executed by the one or more processors, cause the one or more processors to receive, from a data storage unit, a verified data configuration file and parse the verified data configuration file to extract a data provisioning schema. The data provisioning schema defines a query field having one or more filtering parameters and at least one target dataset comprising a plurality of data values. The one or more processors are further configured to extract the plurality of data values of the at least one target dataset and format the plurality of data values of the at least one target dataset in accordance with the data provisioning schema to thereby generate a provisioned data file. The one or more processors are further configured to transmit the provisioned data file to a target application computing device.

An additional example includes a non-transitory computer-readable medium embodying program code that is executable by one or more processors to cause the one or more processors to receive, from a data storage unit, a verified data configuration file and parse the verified data configuration file to extract a data provisioning schema. The data provisioning schema defines a query field having one or more filtering parameters and at least one target dataset comprising a plurality of data values. The one or more processors are further configured to extract the plurality of data values of the at least one target dataset and format the plurality of data values of the at least one target dataset in accordance with the data provisioning schema to thereby generate a provisioned data file. The one or more processors are further configured to transmit the provisioned data file to a target application computing device.

This summary is not intended to identify the key or essential features of the claimed subject matter, nor is it intended to be used in isolation to determine the scope of the claimed subject matter. Rather, the summary is merely a simplified and non-limiting summary of the innovation that is intended to provide a basic understanding of some aspects of the innovation. The subject matter should be understood by reference to appropriate portions of the entire specification of this disclosure, any or all drawings, and each claim.

To the accomplishment of the foregoing and related ends, certain illustrative aspects of the innovation are described herein in connection with the following description and the annexed drawings. These aspects are indicative, however, of but a few of the various ways in which the principles of the innovation may be employed and the subject innovation is intended to include all such aspects and their equivalents. Other advantages and novel features of the innovation will become apparent from the following detailed description of the innovation when considered in conjunction with the drawings.

### BRIEF DESCRIPTION OF THE DRAWINGS

Various non-limiting embodiments are further described with reference to the accompanying drawings, in which:

FIG. 1 is a block diagram illustrating an example of a computing environment for provisioning data, according to one or more aspects of the present disclosure.

FIG. 2 is a block diagram illustrating the data contract registration application of FIG. 1, according to one or more aspects of the present disclosure.

FIG. 3 is a block diagram illustrating the data provisioning application of FIG. 1, according to one or more aspects of the present disclosure.

FIG. 4 is a block diagram illustrating an example computer-readable medium or computer-readable device including processor-executable instructions configured to embody one or more aspects of the present disclosure.

FIG. 5 is a block diagram illustrating an example system configured to implement examples of one or more aspects of the present disclosure.

FIG. 6 is a flowchart illustrating an example process for provisioning data using a data provisioning architecture according to one or more aspects of the present disclosure.

### DETAILED DESCRIPTION

In the following description, for the purposes of explanation, specific details are set forth in order to provide a thorough understanding of certain embodiments. However, it will be apparent that various embodiments may be practiced without these specific details. The figures and description are not intended to be restrictive. The words “exemplary” or “example” are used herein to mean “serving as an example, instance, or illustration.” Any embodiment or design described herein as “exemplary,” or “example” is not necessarily to be construed as preferred or advantageous over other embodiments or designs.

Reference will now be made in detail to various and alternative illustrative examples and to the accompanying drawings. Each example is provided by way of explanation, and not as a limitation. It will be apparent to those skilled in the art that modifications and variations can be made. For instance, features illustrated or described as part of one example may be used on another example to yield a still further example. Thus, it is intended that this disclosure include modifications and variations as come within the scope of the appended claims and their equivalents.

### Illustrative Example of a Data Provisioning Architecture

In the enterprise setting, a number of technology platforms exist (e.g., internal or external tools) that provide users or business units within the enterprise the ability to collect and store large amounts of data. The data may be received (e.g., through interfacing with one or more application programming interfaces (APIs)) and stored by an enterprise in a central repository, often referred to as a “data lake,” “data mesh,” or “security data platform” (SDP). Users or business units within the enterprise may access the stored data in the central repository for various downstream use cases such as various analytics or insights processes performed by the enterprise. As such, there is a need in the enterprise setting to transmit large amounts data from the centralized repository to such downstream use cases.

Conventional techniques for data provisioning from centralized repositories typically involve an intake process where a downstream user or business unit submits a request to receive certain data. Responsive to the request, a developer (e.g., an internal administrator of the central repository) is assigned to the downstream user or business unit. The developer then performs steps that can involve collecting the data requirements specified in the request, coding and unit testing for the requested data, integration testing of the requested data, and in some cases, even establishing a route between the source of the dataset to the destination (e.g., via file streaming or other suitable route establishment) (hereinafter referred to as a “software development lifecycle process” (SDLP)). Conventional SDLP pipelines and conventional techniques for data provisioning can often weeks, months, or even longer before the data is appropriately provisioned and deployed (e.g., transmitted to downstream users).

Embodiments of the present disclosure provide a self-servicing process flow in the SDLP context that utilizes a decoupled data provisioning architecture. More specifically, embodiments of the present disclosure leverage a self-service data contract registration process followed by a date provisioning process to provision data files to downstream target users and target applications. As used herein, data contracts are pre-registered and pre-verified data configuration files that include a unique target application identifier and accompanying technical specifications which provide instructions to a data provisioning application during runtime and identifies a target application computing device associated with the data contract. The data contracts include a data provisioning schema that is executed by a data provisioning application. During runtime, the data provisioning application extracts, from an SDP, source data in accordance with the data provisioning schema. The data provisioning application formats the extracted source data into a standardized format and transmits the provisioned data to a downstream target.

In more detail, a downstream target can submit a request for data. The request can include a network data mover (NDM) specifying a file path for the requested data, and the request can include a target dataset (or datasets) that the downstream target would like provisioned. The NDM is invoked during runtime (e.g., during data provisioning) by the data provisioning application to transmit the provisioned data long the file route specified in the NDM. The request for data may be in the form of a JavaScript Object Notation (JSON) configuration file. The request can include additional fields (herein referred to as “data provisioning schema fields”) including, but not limited to, a downstream application ID associated with the target system, a downstream contact/email IDs associated with the specific target user, a name of the dataset as specified in a centralized data catalog hosted by an enterprise, a data extraction frequency or time period (e.g., periodic, daily, monthly, quarterly, etc.), specific subsets of a data from a particular dataset of sources (e.g., particular columns of interest), dataset filtering criteria (e.g., data values satisfying a particular filtering threshold such as all data values over/under a particular threshold), query terms, quality check parameters and evaluation metrics (e.g., data values satisfying a certain accuracy threshold metric), NDM configuration details, a target system connection stream, and so on.

As part of the data contract registration process, the data provisioning system can authenticate the downstream target by verifying that the downstream target has an appropriate authorization level to view and obtain the requested data. In some embodiments, the validation check can involve comparing a title, position, name, etc. of a target ID in the request with an access list stored, for example, in the data catalog. That is, the data contract registration process is integrated with an enterprise-maintained data catalog to ensure that downstream targets possess all required permissions to access the requested data and to make sure that all the security constraints are satisfied. Further, and as part of the data contract registration process, the request (e.g., the original JSON configuration file) may be transformed into a standard configuration file format thereby created a verified configuration file (e.g., a registered and verified data contract) (hereafter referred to as a “verified configuration file” or a “data contract”). The generated data contract may also include a unique data contract ID and with technical specifications as well as a job schedule associated with the data contract specifying when and how the data contract should be executed.

Then, after the data contract registration process, a data provisioning application receives the data contract as input. The data provisioning application reads and parses the data contract and extract the datasets of interest in accordance with the data provisioning schema of the data contract (e.g., in accordance with a frequency parameter, a timing parameter, a filtering parameter, etc.). The data provisioning application can, in some examples, perform quality checks on the provisioned data to ensure an accuracy level. The data provisioning application can also log telemetry data associated with the provisioning request. The data provisioning application can also format the provisioned data in accordance with the data provisioning schema (e.g., a table format, a particular file format, and so on). In some examples, the provisioned data may be formatted for a particular third party system, such as a “hyper” file readable by a Tableau server. The provisioned data file or provisioned data files are then transmitted to the downstream target by invoking suitable NDM software to transfer the provisioned data file(s) along a network route specified by the NDM.

The described techniques provide improvements to be the functioning of a computer as well as improvements to the technical field of data management. For example, in many businesses, data is often managed within multiple different teams by multiple different leaderships, and in the context of SDLP, developers often serve as intermediaries. As a result, data may be managed manually and in an ad hoc fashion by using multiple different nonconsolidated spreadsheets, emails, or sharepoints in a slow and manually manner. The techniques of this disclosure may replace ad hoc enterprise data management repositories that were built using spreadsheets or sharepoints with a self-service data provisioning architecture that enables automatic data provisioning for downstream target users and target applications. The techniques of this disclosure may ensure greater data quality, accuracy, and completeness while also improving the efficiency of data collection and provisioning.

While certain embodiments are described, these embodiments are presented by way of example only and are not intended to limit the scope of protection. The apparatuses, methods, and systems described herein may be embodied in a variety of other forms. Furthermore, various omissions, substitutions, and changes in the form of the example methods and systems described herein may be made without departing from the scope of protection. Further details regarding the systems and methods are provided below in relation to the drawings.

### Example Systems for Implementing a Data Provisioning Architecture

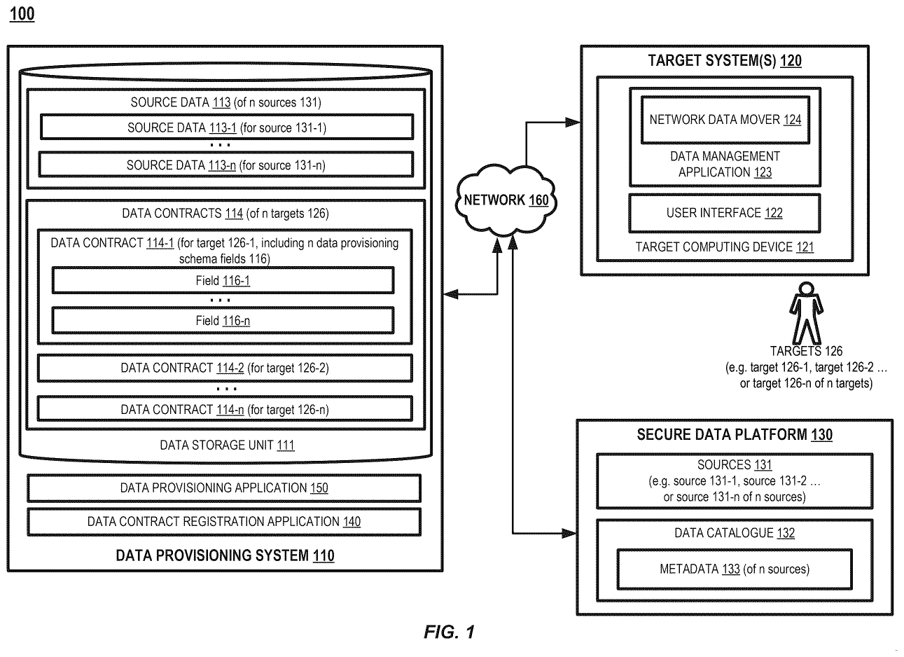

Referring now to the drawings, FIG. 1 depicts an example of a computing environment 100 for provisioning data files for target systems 120, according to one or more aspects of the present disclosure. The computing environment 100 includes a data provisioning system 110 that can communicate via a network 160 with one or more target systems 120 and with a secure data platform 130.

In certain embodiments, the target device computing device 121 of target system(s) 120 includes a user interface 122 and a data management application 123 including a network data mover 124. In a distributed computing environment, such as computing environment 100, a multitude of target systems 120 may be provided and connected via network 160 to the data provisioning system 110. That is, target systems 120, including respective target computing devices, such as target computing device 121, may be associated with targets 126 (e.g., target 126-1, target 126-2,. target 126-n of n targets 126) each operating or otherwise being associated with a respective target computing device. Targets 126 may represent individuals or groups of individuals, third party systems, business units, or entities having a having a technical and/or business relationship with an enterprise hosting the data provisioning system 110.

In certain embodiments, a specific target (e.g., target 126-1) may interact, via user interface 122, with data management application 123 on target computing device 121. User interface 122 enables target 126-1 to interact with the target computing device 121. The user interface 122 may be a touch screen interface, a voice-based interface, or any other interface that allows target 126-1 to provide input and receive output from one or more applications on the target computing device 121. For instance, target 126-1 of the target computing device 121 may interact with the data management application 150 via the user interface 122. In an example, the target 126-1 interacts via the user interface 122 with the data management application 150 to request data provisioning, from the data provisioning system 110, of one or more datasets or data files. In more detail, target 126-1 may request provisioning of one or more data files from data provisioning system 110. Data files may be extracted by data provisioning system 110 from secure data platform 130 from sources 131 where each of sources 131 (e.g., source 131-1, 131-2, . . . 131-n) may refer to datasets usable and retrieved from various upstream domain specific data sources associated with the enterprise hosting the data provisioning system 110. For instance, source 131-1 may be associated with a vulnerability management data domain, source 131-2 may be associated with an infrastructure systems application log, source 131-3 may be associated with a customer information and so on. It will be appreciated that a single source (e.g., source 131-1) may include a single dataset from the specific data domain or multiple datasets associated with the specific data domain. Once extracted by the data provisioning system 110, the sources 131 are stored in data storage unit 111 as source data 113 for n sources 131 (e.g., source data 113-1 for source 131-1,. source data 113-n for source 131-n).

Secure data platform 130 also includes data catalog 132. In some embodiments, data catalog 132 can include metadata 133 associated with sources 131 and their respective datasets. As used herein, the data catalog 132 can provide a unified view for managing data in an enterprise setting thus ensuring appropriate usage of data. For example, data catalog 132 may utilize platform and vendor agnostic APIs to collect metadata 133 from upstream data platforms (including technical metadata, business metadata, data quality, and lineage, etc.), collect data use cases (including regulatory use cases, risk use cases, or operational use cases deployed on one or more data reporting platforms, data analytics platforms, data modeling platforms, etc.), and collect data governance policies or procedures and assessment outcomes (including one or more of data risks, data controls, or data issues retrieved from risk systems, etc.) from risk platforms. The data catalog 132 may then define data domains aligned to a particular reporting structure, such as that used to report financial details in accordance with requirements established by the Security and Exchange Commission, or according to other enterprise-established guidelines. The data catalog 132 may further build data insights, reporting, scorecards, and metrics for transparency on the status of data assets and corrective actions. This metadata 133 may be used to label the datasets of sources 131 and when data provisioning system 110 extracts the datasets from secure data platform 130, data provisioning system 110 may also extract the metadata 133. In some embodiments, metadata 133 may be transmitted to downstream targets, such as target system 120, during the data provisioning process to provide further information to targets 126.

In some embodiments, data catalog 132 can simplify data flows during the data provisioning process. For example, generation of a regulatory report (or other type of data provisioning request) may conventionally source data from X number of sources 131. Based on the insights provided by the data catalog 132 and the relevant metadata 133 of X number of sources 131, processing of the metadata 133 may result in a determination that Y number of data sources of sources 131 can be removed from the data provisioning flow, because those Y data sources are not adding any value to the data or the process, are redundant, and so on. As a result, the data provisioning flow can be simplified to X−Y=Z data sources from sources 131. In another embodiment, a data domain may currently have X number of data provisioning elements, but based on the insights provided by the data catalog 132 and metadata 133, enterprise management may conclude that Y data provisioning elements can be decommissioned due to duplication of data. As a result, the number of data provisioning points can be simplifies to X−Y=Z data provisioning elements thereby reducing the computational expense and time involved with data provisioning.

Staying with FIG. 1, data provisioning system 110 includes data contract registration application 140 and data provisioning application 150. Data provisioning system 110 also includes data storage unit 111, as previously introduced. Data storage unit 111 can be local or remote storage (e.g., remotely accessible by data provisioning system 110). In certain embodiments described herein, data provisioning performed by data provisioning system 110 communicating with target systems 120 and secure data platform 130 may generally involve two steps. A first step, performed by the data contract registration application 140, involves data contract registration to generate data contracts 114 for targets 126. A second step, executed by data provisioning application 150, involves provisioning of the data file(s) as specified by the data contracts 114 for the particular use case.

In more detail, data provisioning application 150 is configured to take as input, one or more data contracts 114 and parse the data provisioning schema fields 116 in the data contracts 114 to generate and output to target systems 120, a provisioned data file or provisioned data files. The provisioned data file(s) are then output and transmitted via network 160 to target systems 120. Embodiments of the present disclosure implementing the data provisioning architecture illustrated by FIG. 1 enable a decoupling and self-service functionality for data provisioning in the enterprise setting. That is, data contract generation and registration may be performed by downstream target systems (i.e., target systems 120) and data provisioning may be automatically performed without requiring an intermediary (e.g., a developer) to process the request, verify the authorization for the requested data, and provision the appropriate files. The decoupled architecture thus improves upon computers in terms of reducing computational resources.

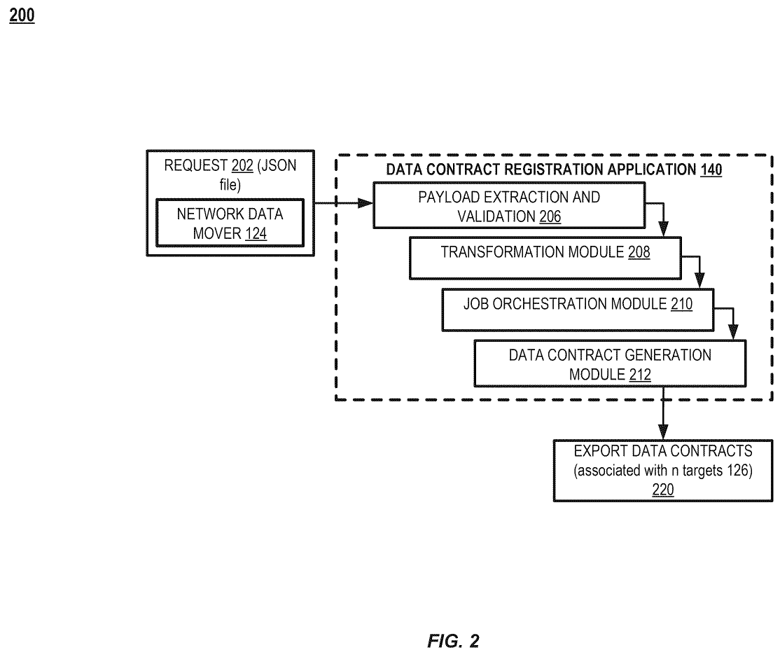

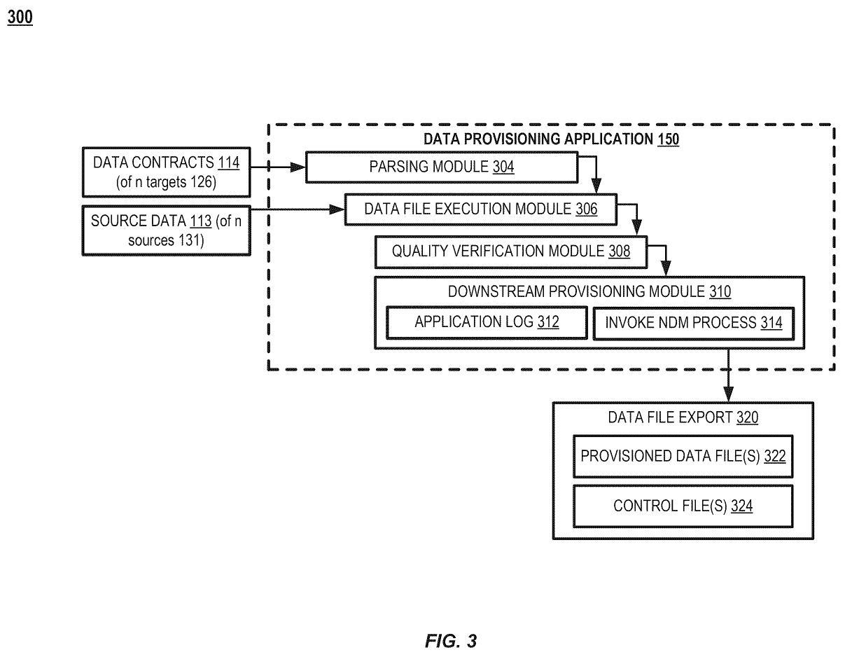

The self-provisioned data contract generation and registration process is described in more detail with respect to FIG. 2, and subsequent data file provisioning is described in more detail with respect to FIG. 3. In general, the self-provisioning data contract generation initiates via a target computing device (e.g., target computing device 121 interacting with data management application 123 to submit a request for certain data (e.g., e.g., certain data from secure data platform 130 extracted by data provisioning system 110 and stored in data storage unit 111 as source data 113). As part of the request, the target computing device 121 can include a network data mover 124 in the request. The NDM 124 specifies a network route that the target computing device 121 would like to receive the data. For instance, an example network route may specify that the target computing device 121 would like to receive the provisioned data files from the secure data platform 130 at the respective target computing device 121. During runtime, suitable NDM software may execute and transfer to the provisioned data files in accordance with the specified network route. The request generated by the target computing device 121, including the network data mover 124, may be formatted as a JSON file and can be transmitted over network 160 where it is received by data provisioning system 110.

The request is then processed by data contract registration application 140. Data contract registration application 140 includes suitable software to read and validate the request and transform the request into a standardized format (e.g., generate a verified configuration file). Additionally, the data contract registration application 140 can implement a job orchestrator to schedule the data provisioning in accordance with a frequency parameter specified in a payload of the request. Moreover, a unique data contract ID and technical specifications are added to the verified configuration file and the verified configuration file is saved to data storage unit 111 as a data contract (e.g., as data contract 114-1). The data contract 144 an include data provisioning schema fields 116 that specify the type of data (e.g., the type of source data 113) associated with the request. Other non-limiting examples of data provisioning schema fields 116 may include a downstream application ID associated with the target system 120, a downstream contact/email IDs associated with the specific target user (e.g., targets 126), a unique job identifier, a name of the dataset as specified in the data catalog 132, a data extraction frequency (e.g., periodic, daily, monthly, quarterly, etc.), specific subsets of a data from a particular dataset of sources 131 (e.g., particular columns of interest), dataset filtering criteria (e.g., data values satisfying a particular filtering threshold such as all data values over/under a particular threshold), query terms, quality check parameters and evaluation metrics (e.g., data values satisfying a certain accuracy threshold metric), NDM configuration details (e.g., associated with NDM 124 as well as a particular NDM software API), a target system connection stream, and so on. After the request is processed and data contracts 114 are generated, data provisioning system 110 provisions the data in accordance with the data contracts 114 and based on a scheduling by the job orchestrator of the data provisioning application 150. The provisioned data files are then output and transmitted, via network 160, to target systems 120.

FIG. 2 is a block diagram 200 illustrating the data contract registration application 140 of FIG. 1, according to one or more aspects of the present disclosure. Data contract registration application 140 can be configured to receive request 202 from target systems 120 via network 160, and generate verified data contracts (e.g., data contracts 114) for export and storage in data storage unit 111 (e.g., via export data contracts (associated with n targets 126) 220). Data contract registration application 140 includes payload extraction and validation 206, transformation module 208, job orchestration module 210, and data contract generation module 212.

Payload extraction and validation 206 receives request 202. In some implementations, request 202 may be a JSON file. Request 202 may be configured and generated by a target (e.g., target 126) associated with a downstream target system 120. The request 202 can include various fields. As shown in FIG. 2, request 202 includes NDM 124. Other fields, however, are possible. As described with respect to FIG. 1, such fields can include, but are not limited to, a downstream application ID associated with the target system 120, a downstream contact/email IDs associated with the specific target user (e.g., targets 126), a name of the dataset as specified in the data catalog 132, and so on. Payload extraction and validation 206 extracts the fields from the request 202 and validates authenticity of the request 202. For instance, payload extraction and validation 206 can perform a validation check to ensure that the target requesting provisioning of data files specified in the request 202 has an appropriate authorization level to view and obtain the requested data. In some embodiments, the validation check can involve comparing a title, position, name, etc. of a target ID in the request 202 with a access list stored, for example, in data catalog 132. As described with respect to FIG. 1, data catalog 132 can include data use cases (including regulatory use cases, risk use cases, or operational use cases deployed on one or more data reporting platforms, data analytics platforms, data modeling platforms, etc.), data governance policies, among other features. In this example, payload extraction and validation 206 can compare the target ID in the request 202 with one or more of the data governance policies to ensure a security of the data requested (e.g., compare a sensitivity level of the data request to an authorization level of the target).

After extracting the payload of the request 202 and validating the request 202, data contract registration application 140 transform the request 202 into a standardized, structured format using transformation module 208. In some examples, transformation module 208 can reformat the request 202 and the payload into a common readable format usable by data provisioning system 110. In some embodiments, transformation module 208 may transform the JSON file into another common configuration file format (e.g., “yet another markup language” (YAML) file format). In some examples, transformation module 208 of data contract registration application 140 can connect with data catalog 132 to inject additional metadata 133 into the re-formatted request. For example, transformation module 208 can inject data location (e.g., a location in secure data platform 130) into the re-formatted request. After the processing performed by transformation module 208, a verified configuration file is output.

Then, job orchestration module 210 can schedule data provisioning as specified in the verified configuration file in accordance with a timing or frequency parameter. More specifically, the job orchestration module 210 can process various verified configuration files and schedule each of them for processing based on a priority level associated with the verified configuration files. For example, certain verified configuration files may be prioritized over others based on an importance level (e.g., high priority) or sensitivity level (e.g., verified configuration files requesting more sensitive data may be scheduled and batched processed together to reduce a chance that sensitive data is intermixed with non-sensitive data). Example sensitive data includes data having personal identifying information (PII) such as customer names, birthdays, addresses, social security numbers, and in the financial context, bank account information, credit card numbers, and so on.

Then, data contract generation module 212 can receive the job schedule from job orchestration module 210 and the verified configuration file from the transformation module 208 to generate a verified data contract. The generated verified data contract can include a unique data contract ID and technical specifications associated with the verified configuration file. In addition, data contract generation module 212 can generate a control file. In some examples, as described in more detail with respect to FIG. 3, the control file may be transmitted to the target 120 in conjunction with the provisioned data file. The target system 120 can compare the data elements of the control file with the provisioned data file (e.g., compare individual data elements) to ensure an accuracy level. The target system 120 can reject the provisioned data file if an accuracy level of the comparison is too low.

In one implementation, an example data contract may comprise the following:
dev: {{Insert Environment Name}}
app_name: {{Insert Cybersecurity Domain_Name}}
   source_name: “Framework_UtilityDB” {{e.g., source 131 Name}}
   source_connection_details: {{Specify NDM}
   db:
   table:
   source:
   output_file_format:
   file_provision_hdfs_path:
   path_to_hyper:
   delimiter:
   Standard Query Language (SQL):
      insert_sourcing_tbl:
      insert_ctl_tbl
      query:
      select_dynamic_query:
      type:
      host: {{Insert Network Host}}
      port:
      username: “sdp_cs_deco_dpl_dev”
      database: {{Insert Source 131}}
      schema: “dpl”

As depicted above, the example data contract includes various fields corresponding to the data provisioning schema fields 116. One such field in the data contract includes a “query” field (also referred to herein as “filtering” parameters). The query field can be specified in the data contract to provide instructions to the data provisioning application 150 as to one or more filtering parameters. In some embodiments, the query can be a static query where the verified data contract does not include any filtering (e.g., without any parameterization) appended to the query. In these examples, the query may simply instruct the data provisioning application 150 to extract data from an entire dataset associated with a source. In some embodiments, the query can be a dynamic query with a single value appended to the query (e.g., one parameter is passed to the data provisioning application 150 during runtime). For example, the one parameter may be a filtering parameter instruction the data provisioning application 150 to extract all data from a particular data. In some embodiments, the query can be a dynamic query with a list of filtering values (e.g., a list of parameters passed to the data provisioning application 150 during runtime). In these examples, the query can instruction the data provisioning application 150 to extract data values from a particular column of a particular dataset, for a particular date range. The data provisioning schema defined by the query field in the verified data contract thereby saves computation resources. In other words, downstream targets may self-provision data and limit (e.g., filter) the data such that during runtime, the data provisioning system 110 only need to extract and transmit data in accordance with the specified technical details of the data contract.

Then, data contract registration application 140 may export data contracts (associated with n targets 126) 220. In more detail, the data contract registration application 140 can store the verified data contracts in storage unit 111 as data contracts 114. The data contracts 114 may then be executed during runtime by the data provisioning application 150 in accordance with a mapping to the job schedule (e.g., as generated by job orchestration module 210).

FIG. 3 is a block diagram 300 illustrating the data provisioning application 150 of FIG. 1, according to one or more aspects of the present disclosure. Data provisioning application 150 can be configured to receive data contracts 114 and source data 113 (of n sources 131) from data storage unit 111 of data provisioning system 110. Data provisioning application 150 can process the data contracts 114 and source data 113 using parsing module 304, data file execution module 306, quality verification module 308, and downstream provisioning module to generate a data file export 320 including provisioned data file(s) 322 and control file(s) 324.

Parsing module 304 of data provisioning application 150 may receive data contracts 114 (of n targets 126). In more detail, parsing module 304 can receive the job schedule and read, as input, the data contract 114 that maps to the particular job that is scheduled. Parsing module 304 can then parse the textual data of the data contracts 114 and create or extract the SQL language from the data contracts 114. For example, the parsing module 304 can extract the data provisioning schema fields 116 as specified in the data contract.

Then, data file execution module 306 can execute suitable software to extract the source data 113 specified by the data provisioning schema of the data contracts 114. As mentioned above, the data provisioning schema of the data contracts 114 can include various query fields with one or more filtering parameters (e.g., static queries, dynamic queries, etc.) that the data provisioning application 150 can execute during runtime to extract the appropriate source data 113.

In some embodiments, quality verification module 308 can perform a quality check on the extracted source data. Quality verification module 308 can apply validation rules and data quality metrics to ensure that the extracted source data 113 is accurate and complete (e.g., to ensure no data was modified or lost during the extraction process from the secure data platform 130 and to ensure that the data being used is of high quality and suitable for its intended use case). A level of quality determined by the quality verification module 308 may be tagged to the provisioned data file(s) 322 and may be viewable by a target 126 of target system 120. In some instances, if a level of quality of the data product is too low (e.g., satisfies a lower threshold), the data provisioning application 150 can be configured to extract the source data 113 again (e.g., a second time, a third time, etc.) until the level of quality satisfies a threshold accuracy and quality level. In some examples, determining the level of quality may be determined by performing a cross-verification (e.g., a comparison) between the source data 113 (i.e., the original raw form of the source data set) and the provisioned data file(s) 322 to determine a data variance. In some examples, a machine learning model may be implemented by the quality verification module 308 to determine a similarly prediction (e.g., a numerical score) indicating a predicted similarity between the source data 113 that is extracted and the provisioned data file(s) 322.

After processing by the quality verification module 308, the provisioned data file(s) 322 may be passed to downstream provisioning module 310. Downstream provisioning module 310 may perform operations associated with transmitting the provisioned data file(s) 322 to the appropriate target system 120 and target 126. For instance, downstream provisioning module 310 may include an invoke NDM process 314 functionalities to transmit the provisioned data file(s) 322 in accordance with the specified network data route (e.g., as specified in the request 202). The invoke NDM process 314, for example, may include suitable NDM software to transmits the provisioned data file(s) 322.

Downstream provisioning module 310 also includes application log 312. Application log 312 can record telemetry data associated with the data provisioning process performed by the data provisioning application 150. The telemetry data can include timing information (e.g., timestamp data associated with how long the process took), quantity metrics data (e.g., a file size indicating how much source data 113 was extracted), and other forms of telemetry data such as one or more statistics regarding the provisioning process (e.g., error data associated with the provisioning process). The telemetry data logged by application log 312 may be provided to the host of the data provisioning system 110 and analyzed to further improve performance in the future by identifying root cause errors, bottlenecks in the data provisioning, and so on. For instance, if certain source data 113 (e.g., of source 131-3) is consistently taking longer to process by data provisioning application 150, application log 312 may be access and analyzed to identify the particular source data 113 to assist a user in understanding why source 131-3 is creating a bottleneck.

Downstream provisioning module 310 then executes a data file export 320 to transmit the provisioned data file(s) 322 to the downstream target system 120. In some embodiments, data file export 320 may also include one or more control files (e.g., control file(s) 324). As described with respect to FIG. 2 control file(s) 324 file may be transmitted to the target 120 in conjunction with the provisioned data file(s) 322 where the target system 120 can compare the data elements of the control file(s) 324 with the provisioned data file(s) 322 (e.g., compare individual data elements) to ensure an accuracy level. In some examples, the control file(s) 324 may be generated using the original, raw form of the source data 113 extracted by the data file execution module 306.

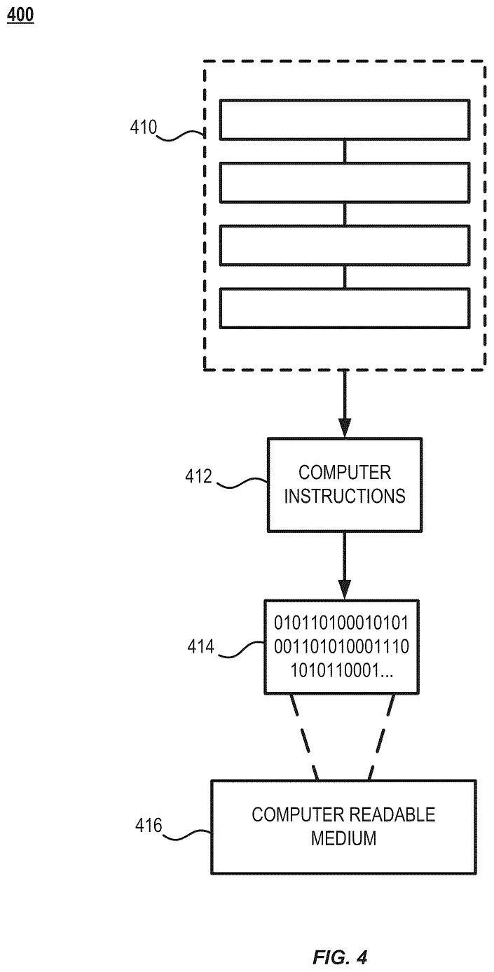

One or more of the aspects of the present disclosure include a computer-readable medium including microprocessor or processor-executable instructions configured to implement one or more embodiments presented herein. FIG. 4 is a block diagram 400 illustrating an example computer-readable medium or computer-readable device including processor-executable instructions configured to embody one or more of the aspects set forth herein. As illustrated in FIG. 4, block diagram 400 includes a computer-readable medium 416. Computer-readable medium 416 can include a CD-R, DVD-R, flash drive, a platter of a hard disk drive, and so forth, on which computer-readable data 414 is encoded and stored. The computer-readable data 414, such as binary data including a plurality of zero's and one's as illustrated, in turn includes a set of computer instructions 412 configured to operate according to one or more of the principles set forth herein.

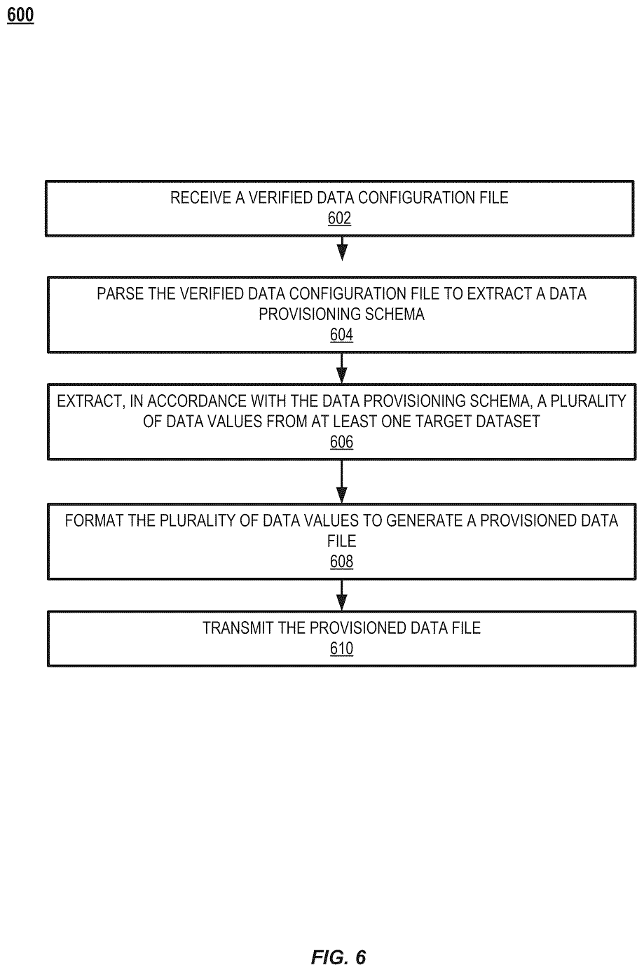

In the illustrated implementation of FIG. 4, the set of computer instructions 412 (e.g., processor-executable computer instructions) may be configured to perform a method 410, such as the process 600 of FIG. 6, described in more detail below, for example. In another embodiment, the set of computer instructions 412 may be configured to implement a system or platform, such as the data provisioning system 110 described with respect to FIG. 1, including data provisioning application 150 and data contract registration application 140, for example. Many such computer-readable media may be devised by those of ordinary skill in the art that are configured to operate in accordance with the techniques presented herein.

As used in this application, the terms “component,” “module,” “system,” “interface,” “manager,” “engine,” and the like are generally intended to refer to a computer-related entity, either hardware, a combination of hardware and software, software, or software in execution. For example, a component may be, but is not limited to being, a process running on a processor, a processor, an object, an executable, a thread of execution, a program, or a computer. By way of illustration, both an application running on a controller and the controller may be a component. One or more components residing within a process or thread of execution and a component may be localized on one computer or distributed between two or more computers.

A device may also be called and may contain some or all of the functionality of a system, subscriber unit, subscriber station, mobile station, mobile, mobile device, wireless terminal, device, remote station, remote terminal, access terminal, user terminal, terminal, wireless communication device, wireless communication apparatus, user agent, user device, or user equipment (UE). A mobile device may be a cellular telephone, a cordless telephone, a Session Initiation Protocol (SIP) phone, a smart phone, a feature phone, a wireless local loop (WALL) station, a personal digital assistant (PDA), a laptop, a handheld communication device, a handheld computing device, a netbook, a tablet, a satellite radio, a data card, a wireless modem card, and/or another processing device for communicating over a wireless system. Further, although discussed with respect to wireless devices, the disclosed aspects may also be implemented with wired devices, or with both wired and wireless devices.

Further, the claimed subject matter may be implemented as a method, apparatus, or article of manufacture using standard programming or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, many modifications may be made to this configuration without departing from the scope or spirit of the claimed subject matter.

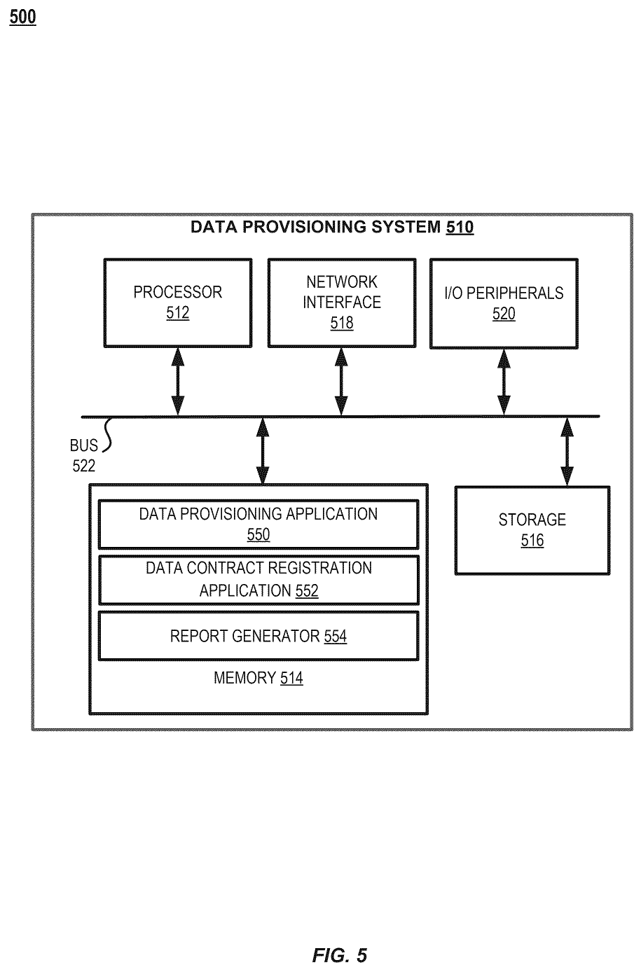

Turning now to FIG. 5, which depicts an example of a computing environment 500 for implementing examples of one or more aspects of the present disclosure. The computing environment 500 of FIG. 5 is merely one example of a suitable operating environment configured to implement a data provisioning system 510 and is not intended to suggest any limitation as to the scope of use or functionality of the operating environment. Example computing devices include, but are not limited to, personal computers, server computers, hand-held or laptop devices, mobile devices, such as mobile phones, Personal Digital Assistants (PDAs), media players, and the like, multiprocessor systems, consumer electronics, mini-computers, mainframe computers, distributed computing environments that include any of the above systems or devices, etc.

Generally, embodiments are described in the general context of “computer readable instructions” being executed by one or more computing devices. Computer readable instructions may be distributed via computer readable media as will be discussed below. Computer readable instructions may be implemented as program modules, such as functions, objects, APIs, data structures, and the like, which perform one or more tasks or implement one or more abstract data types. Typically, the functionality of the computer readable instructions is combined or distributed as desired in various environments.

FIG. 5 is a block diagram illustrating an example data provisioning system 510 configured to provision data files using data contract registration application 552 and data provisioning application 550, according to one or more aspects of the present disclosure. In one configuration, the data provisioning system 510 may include at least one processor 512 and at least one memory 514. Depending on the exact configuration and type of computing device, the at least one memory 514 may be volatile, such as RAM, non-volatile, such as ROM, flash memory, etc., or a combination thereof. Examples of processor 512 include a microprocessor, an application-specific integrated circuit (ASIC), a field-programmable gate array (FPGA), or any other suitable processing device. Data provisioning system 510 can include one processor, such as is illustrated by processor 512 in FIG. 5, or more than one processor.

Memory 514 may include additional features or functionality including one or more programs and/or program data that may be accessible in memory 514 by the data provisioning system 510. For example, memory 514 includes data provisioning application 550 and data contract registration application 552. The one or more programs and/or program data that may be accessible in memory 514 by the data provisioning system 510 may implement the functionalities described above with respect FIGS. 1, 2 and 3. For instance, Data provisioning system 510 may implement data contract registration application 552 to execute the data contract registration functionality as described with respect to FIGS. 1 and 2 and the data provisioning system 510 may implement data provisioning application 550 to provision data files for downstream target systems as described with respect to FIGS. 1 and 3. In some examples, one or more of data provisioning application 550 and data contract registration application 552 may be stored in memory 514 and may be accessed by a separate computing device (e.g., target computing device 121 of target system 120) via a suitable application program interface (API). In some examples each of data provisioning application 550 and data contract registration application 552 may be configured to function across different types of hardware and software platforms used by the target computing device 111 of target system 120 of n target users (e.g., Windows, Linux, etc); therefore, data provisioning application 550 and data contract registration application 552 provides a consistent and standardized way of access and implementation across different computing devices in a distributed computing environment.

Memory 514 also include report generator 554. Report generator may generate, based on data contract(s) 114 and provisioned data files, a report. The report may include additional information for the downstream target computing device 121 of target system 120 of n target users such as a level of quality of provisioned data product (e.g., a level of accuracy or verification that the provisioned data product is complete), one or more statistics regarding the provisioning process (e.g., telemetry data), or additional metadata providing additional descriptions or information about the provisioned data file. The generated report assists a downstream target system 120 in terms of gaining a better understanding of the data provisioning process which ultimately may aid in gaining better understanding of the state of the data and better business insights. Memory 514 may also store other programs and data not specifically identified herein.

Data provisioning system 510 may include additional features or functionality. For example, the data provisioning system 510 may include storage such as removable storage or non-removable storage, including, but not limited to, magnetic storage, optical storage, etc. Such storage is illustrated in FIG. 5 by storage 516. In one or more embodiments, computer readable instructions to implement one or more embodiments provided herein are in the storage 516. The storage 516 may store other computer readable instructions to implement an operating system, an application program, etc. Computer readable instructions may be loaded in the at least one memory 514 for execution by the at least one processor 512, for example.

Computing devices may include a variety of media, which may include computer-readable storage media or communications media, which two terms are used herein differently from one another as indicated below.

Computer-readable storage media may be any available storage media, which may be accessed by the computer and includes both volatile and nonvolatile media, removable and non-removable media. By way of example, and not limitation, computer-readable storage media may be implemented in connection with any method or technology for storage of information such as computer-readable instructions, program modules, structured data, or unstructured data. Computer-readable storage media may include, but are not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or other tangible and/or non-transitory media which may be used to store desired information. Computer-readable storage media may be accessed by one or more local or remote computing devices (e.g., via access requests, queries, or other data retrieval protocols) for a variety of operations with respect to the information stored by the medium.

Communications media typically embody computer-readable instructions, data structures, program modules, or other structured or unstructured data in a data signal such as a modulated data signal (e.g., a carrier wave or other transport mechanism) and includes any information delivery or transport media. The term “modulated data signal” (or signals) refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

Still referring to FIG. 5, the computing environment 500 may also include a number of additional external or internal devices, for example, input or output devices. For example, data provisioning system 510 is illustrated as including input/output (I/O) peripherals 520. I/O peripherals 520 can receive input from an input device (not shown) or provide output to output devices (not shown). Input peripherals can include a variety of different input devices such as keyboards, mouses, pens, voice input devices, touch input devices, infrared cameras, video input devices, or any other input device. Output peripherals can include a variety of different output devices such as one or more displays, speakers, printers, or any other output device may be included with the data provisioning system 510.

I/O peripherals 520 may be connected to the data provisioning system 510 via a wired connection, wireless connection, or any combination thereof. Further, the data provisioning system 510 may include network interface 518 to facilitate communications with one or more other devices (not shown). Network interface 518 can include any device or group of devices suitable for establishing a wired or wireless data connection to one or more data networks. Non-limiting examples of the network interface 518 include an Ethernet network adaptor, a wireless network adapter, a modem, Wi-Fi adapter, Bluetooth adapter, near field communication (NFC) receiver and transmitter, and any other known wired or wireless data transmission system. Data provisioning system 510 also includes bus 522. Although only one interface bus is illustrated, computing environment 500 can include more than one interface bus. Bus 522 can communicatively couple one or more components of data provisioning system 510.

### Example Methods for Provisioning Data Files Using a Data Provisioning Architecture

Turning now to FIG. 6, which is a flowchart of an example of a process 600 for provisioning data files using a data provisioning architecture, according to one or more aspects of the present disclosure. The process 600 will be described with respect to the data provisioning system 110 shown in FIG. 1, the data contract registration application 140 described with respect to FIG. 2, and the data provisioning application 150 described with respect to FIG. 3; however, any suitable system or platform according to this disclosure may be employed, including the example data provisioning system 510 shown in FIG. 5. Additionally, process 600 is provided in the order shown, but other orders or additional steps may be provided.

As shown in FIG. 6, the process 600 begins at step 602, when the data provisioning application 150 receives a verified data configuration file. The verified data configuration file may be generated by the data contract registration application 140 responsive to receiving request 202. The verified data configuration file may correspond to the data contracts 114 stored in the data storage unit 111. The data contract 144 an include data provisioning schema fields 116 that specify the type of data (e.g., the type of source data 113) associated with the request 202. Other non-limiting examples of data provisioning schema fields 116 may include a unique downstream application/target ID associated with the target system 120, a downstream contact/email IDs associated with the specific target user (e.g., targets 126), a name of the dataset as specified in the data catalog 132, a data extraction frequency (e.g., periodic, daily, monthly, quarterly, etc.), specific subsets of a data from a particular dataset of sources 131 (e.g., particular columns of interest), dataset filtering criteria (e.g., data values satisfying a particular filtering threshold such as all data values over/under a particular threshold), query terms, quality check parameters and evaluation metrics (e.g., data values satisfying a certain accuracy threshold metric), NDM configuration details (e.g., associated with NDM 124 as well as a particular NDM software API), a target system connection stream, and so on.

The data contracts 114 may be “verified” meaning that the data contract registration application 140 has successful performed a validation check on the request 202 to ensure that the target requesting provisioning of data files specified in the request 202 has an appropriate authorization/access level to view and obtain the requested data. As previously described, the validation check can involve comparing a title, position, name, etc. of a target ID in the request 202 with a access list stored, for example, in data catalog 132, where the data catalog 132 includes data use cases (including regulatory use cases, risk use cases, or operational use cases deployed on one or more data reporting platforms, data analytics platforms, data modeling platforms, etc.), data governance policies, among other features.

Next at step 604, the parsing module 304 can parse the verified data configuration file to extract the data provisioning schema. More specifically, parsing module 304 parses the textual data of the data contracts 114 and create or extract the SQL from the data contracts 114. As mentioned above, the data provisioning schema of the data contracts 114 can include various query fields with one or more filtering parameters (e.g., static queries, dynamic queries, etc.) that the data provisioning application 150 can execute during runtime to extract the appropriate source data 113. Other fields may also be included in the data contracts 114.

Next at step 606, the data file execution module 306 can extract, in accordance with the data provisioning schema fields 116, a plurality of data values from at least one target dataset. In some examples, extraction by the data file execution module 306 is performed in accordance and in an order specified by job orchestration module 210. That is, job orchestration module 210 can schedule extraction associate with the data provisioning request in accordance with a timing or frequency parameter as specified in the verified data configuration file based on priority levels, sensitivity levels, or other metrics.

Then at step 608, the data provisioning application 150 can format the plurality of data values to generate provisioned data file(s) 322. More specifically, downstream provisioning module 310 may perform operations associated with organizing the extracted data into a provisioned data file(s) 322. In some examples, downstream provisioning module 310 in accordance with a specific format (e.g., a table, list, etc.) and a specific file type (e.g., csv, pdf, etc.) as specified in the data provisioning schema fields 116 of the data contract 114 (e.g., the verified configuration file).

In some examples, data provisioning application 150 may be configured to execute a quality verification module 308 to perform a quality check on provisioned data file(s) 322. As described with respect to FIG. 3, quality verification module 308 can apply validation rules and data quality metrics to ensure that the extracted source data 113 is accurate and complete (e.g., to ensure no data was modified or lost during the extraction process from the secure data platform 130 and to ensure that the data being used is of high quality and suitable for its intended use case). A level of quality determined by the quality verification module 308 may be tagged to the provisioned data file(s) 322 and may be viewable by a target 126 of target system 120, and in some instances, if a level of quality of the data product is too low (e.g., satisfies a lower threshold), the data provisioning application 150 can be configured to extract the source data 113 again (e.g., a second time, a third time, etc.) until the level of quality satisfies a threshold accuracy and quality level.

Next at step 610, the data provisioning application 150 can transmit the provisioned data file(s) 322. In this step, the downstream provisioning module 310 can transmit, via data file export 320, the provisioned data file(s) 322 to the appropriate target system 120 and target 126. To do so, downstream provisioning module 310 may include an invoke NDM process 314 functionalities to transmit the provisioned data file(s) 322 in accordance with the specified network data route (e.g., as specified in the request 202). The invoke NDM process 314, for example, may include suitable NDM software to transmit the provisioned data file(s) 322 along the specified network route.

In some embodiments, data file export 320 may also include one or more control files (e.g., control file(s) 324). As described with respect to FIGS. 2 and 3 control file(s) 324 file may be transmitted to the target 120 in conjunction with the provisioned data file(s) 322 where the target system 120 can compare the data elements of the control file(s) 324 with the provisioned data file(s) 322 (e.g., compare individual data elements) to ensure an accuracy level. In some examples, the control file(s) 324 may be generated using the original, raw form of the source data 113 extracted by the data file execution module 306.

### General Considerations

Numerous specific details are set forth herein to provide a thorough understanding of the claimed subject matter. However, those skilled in the art will understand that the claimed subject matter may be practiced without these specific details. In other instances, methods, apparatuses, or computing systems that would be known by one of ordinary skill have not been described in detail so as not to obscure claimed subject matter.

Unless specifically stated otherwise, it is appreciated that throughout this specification discussions utilizing terms such as “generating,” “processing,” “computing,” and “determining” or the like refer to actions or processes of a computing device, such as one or more computers or a similar electronic computing device or devices that manipulate or transform data represented as physical electronic or magnetic quantities within memories, registers, or other information storage devices, transmission devices, or display devices of the computing platform.

The computing system or computing systems discussed herein are not limited to any particular hardware architecture or configuration. A computing device can include any suitable arrangement of components that provide a result conditioned on one or more inputs. Suitable computing devices include multi-purpose microprocessor-based computer systems accessing stored software that programs or configures the computing system from a general-purpose computing apparatus to a specialized computing apparatus implementing one or more implementations of the present subject matter. Any suitable programming, scripting, or other type of language or combinations of languages may be used to implement the teachings contained herein in software to be used in programming or configuring a computing device.

Various operations of embodiments are provided herein. The order in which one or more or all of the operations are described should not be construed as to imply that these operations are necessarily order dependent. Alternative ordering will be appreciated based on this description. Further, not all operations may necessarily be present in each embodiment provided herein.

As used in this application, “or” is intended to mean an inclusive “or” rather than an exclusive “or.” Further, an inclusive “or” may include any combination thereof (e.g., A, B, or any combination thereof). In addition, “a” and “an” as used in this application are generally construed to mean “one or more” unless specified otherwise or clear from context to be directed to a singular form. Additionally, at least one of A and B and/or the like generally means A or B or both A and B. Further, to the extent that “includes,” “having,” “has,” “with,” or variants thereof are used in either the detailed description or the claims, such terms are intended to be inclusive in a manner similar to the term “comprising.” The use of “configured to” or “based on” herein is meant as open and inclusive language that does not foreclose devices adapted to or configured to perform additional tasks or steps. The endpoints of comparative limits are intended to encompass the notion of quality. Thus, expressions such as “more than” should be interpreted to mean “more than or equal to.”

Where devices, computing systems, components or modules are described as being configured to perform certain operations or functions, such configuration can be accomplished, for example, by designing electronic circuits to perform the operation, by programming programmable electronic circuits (such as microprocessors) to perform the operation such as by executing computer instructions or code, or processors or cores programmed to execute code or instructions stored on a non-transitory memory medium, or any combination thereof. Processes can communicate using a variety of techniques including but not limited to conventional techniques for inter-process communications, and different pairs of processes may use different techniques, or the same pair of processes may use different techniques at different times. Headings, lists, and numbering included herein are for ease of explanation only and are not meant to be limiting.

While the present subject matter has been described in detail with respect to specific embodiments thereof, it will be appreciated that those skilled in the art, upon attaining an understanding of the foregoing, may readily produce alterations to, variations of, and equivalents to such embodiments. Accordingly, it should be understood that the present disclosure has been presented for purposes of example rather than limitation and does not preclude inclusion of such modifications, variations, and/or additions to the present subject matter as would be readily apparent to one of ordinary skill in the art.

What is claimed is:

1. A computer-implemented method comprising:
receiving, by a data provisioning computing system from a data storage unit, a verified data configuration file;
parsing, by the data provisioning computing system, the verified data configuration file to extract a data provisioning schema, the data provisioning schema defining:
a query field having one or more filtering parameters; and
at least one target dataset comprising a plurality of data values;
extracting, by the data provisioning computing system, the plurality of data values of the at least one target dataset;
formatting, by the data provisioning computing system, the plurality of data values of the at least one target dataset in accordance with the data provisioning schema to thereby generate a provisioned data file; and
transmitting, by the data provisioning computing system to a target application computing device, the provisioned data file.

2. The computer-implemented method of claim 1, wherein the data provisioning schema further comprises a unique target application identifier that identifies a target application computing device associated with the verified data configuration file.

3. The computer-implemented method of claim 2, wherein the data provisioning schema further comprises preconfigured authorizations associated with the target application computing device, and wherein the computer-implemented method further comprises:
verifying, prior to transmitting the provisioned data file and based on the preconfigured authorizations, an access level of the target application computing device to the at least one target dataset.

4. The computer-implemented method of claim 1, further comprising:
verifying a level of quality of the provisioned data file based on a comparison to a control file; and
transmitting, in conjunction with transmitting the provisioned data file, a data object associated with a result of the comparison.

5. The computer-implemented method of claim 4, further comprising:
outputting, responsive to the level of quality satisfying a threshold, an indication of an error on a display of the target application computing device; and
extracting, the plurality of data values of the at least one target dataset a second time.

6. The computer-implemented method of claim 1, wherein the verified data configuration file further comprises a network data mover defining a file transfer route from the data provisioning computing system to the target application computing device.

7. The computer-implemented method of claim 6, wherein transmitting the provisioned data file further comprises:
invoking a file transfer process via an application programming interface, to transmit the provisioned data file in accordance with the network data mover.

8. The computer-implemented method of claim 1, wherein the one or more filtering parameters comprise a dynamic filtering parameter defining a frequency of extraction of the plurality of data values of the at least one target dataset, a time period of extraction, or any combination thereof.

9. The computer-implemented method of claim 1, wherein the data storage unit comprises a plurality of verified data configuration files, wherein each verified data configuration file comprises a unique job identifier, wherein the computer-implemented method further comprises:
mapping, via a job orchestrator of the data provisioning computing system, each unique job identifier to a job orchestration repository schedule; and
parsing each verified data configuration file of the plurality of verified data configuration files in an order associated with the job orchestration repository schedule.

10. The computer-implemented method of claim 1, wherein the verified data configuration file is generated by transforming a payload of a JavaScript Object Notation (JSON) file into a structured format.

11. The computer-implemented method of claim 1, further comprising logging, by the data provisioning computing system, telemetry data associated with generating and transmitting the provisioned data file, the telemetry data comprising timestamp data, file size data of the provisioned data file, and error data.

12. A system comprising:
one or more processors; and
a memory coupled to the one or more processors, the memory including instructions that, when executed by the one or more processors, cause the one or more processors to:
receive, from a data storage unit, a verified data configuration file;
parse the verified data configuration file to extract a data provisioning schema, the data provisioning schema defining:
a query field having one or more filtering parameters; and
at least one target dataset comprising a plurality of data values;
extract the plurality of data values of the at least one target dataset;
format the plurality of data values of the at least one target dataset in accordance with the data provisioning schema to thereby generate a provisioned data file; and
transmit the provisioned data file to a target application computing device.

13. The system of claim 12, wherein the data provisioning schema further comprises a unique target application identifier that identifies a target application computing device associated with the verified data configuration file.

14. The system of claim 12, wherein the data provisioning schema further comprises preconfigured authorizations associated with the target application computing device, and wherein the instructions further cause the one or more processors to:
verify, prior to transmitting the provisioned data file and based on the preconfigured authorizations, an access level of the target application computing device to the at least one target dataset.

15. The system of claim 12, wherein the instructions further cause the one or more processors to:
verify a level of quality of the provisioned data file based on a comparison to a control file; and
transmit, in conjunction with transmitting the provisioned data file, a data object associated with a result of the comparison.

16. The system of claim 15, wherein the instructions further cause the one or more processors to:
output, responsive to the level of quality satisfying a threshold, an indication of an error on a display of the target application computing device; and
extract, the plurality of data values of the at least one target dataset a second time.

17. The system of claim 12, wherein the verified data configuration file further comprises a network data mover defining a file transfer route to the target application computing device, and wherein the instructions further cause the one or more processors to invoke a file transfer process via an application programming interface, to transmit the provisioned data file in accordance with the network data mover.

18. The system of claim 12, wherein the one or more filtering parameters comprise a dynamic filtering parameter defining a frequency of extraction of the plurality of data values of the at least one target dataset, a time period of extraction, or any combination thereof, and wherein the verified data configuration file is generated by transforming a payload of a JavaScript Object Notation (JSON) file into a structured format.

19. The system of claim 12, wherein the data storage unit comprises a plurality of verified data configuration files, wherein each verified data configuration file comprises a unique job identifier, wherein the instructions further cause the one or more processors to:
map each unique job identifier to a job orchestration repository schedule; and
parse each verified data configuration file of the plurality of verified data configuration files in an order associated with the job orchestration repository schedule.

20. A non-transitory computer-readable medium embodying program code that is executable by one or more processors to cause the one or more processors to:
receive, from a data storage unit, a verified data configuration file;
parse the verified data configuration file to extract a data provisioning schema, the data provisioning schema defining:
a query field having one or more filtering parameters; and
at least one target dataset comprising a plurality of data values;
extract the plurality of data values of the at least one target dataset;
format the plurality of data values of the at least one target dataset in accordance with the data provisioning schema to thereby generate a provisioned data file; and
transmit the provisioned data file to a target application computing device.
